(19) United States
(12) Patent Application Publication
(10) Pub. No.: US 2025/0381091 A1
(43) Pub. Date: Dec. 18, 2025

(54) Therapeutic Device for Trigger Point Therapy and Myofascial Release

(71) Applicant: Alex Kraft, Minneapolis, MN (US)

(72) Inventor: Alex Kraft, Minneapolis, MN (US)

(21) Appl. No.: 19/081,031

(22) Filed: Mar. 17, 2025

Related U.S. Application Data
(60) Provisional application No. 63/659,570, filed on Jun. 13, 2024.

(51) Int. Cl. A61H 15/00; A61H 15/02

(52) U.S. Cl. CPC A61H 15/0092; A61H 2015/005; A61H 2015/0071; A61H 15/02; A61H 2201/0157; A61H 2201/1253

(57) ABSTRACT

The present invention relates to a self-administered therapeutic device designed for trigger point therapy, myofascial release, and deep-tissue massage. The device comprises a central node connecting a plurality of compression spherical members arranged in a tetrahedral configuration. Each spherical member is about 2.5 inches in diameter and is adapted to spin and roll over the appendage of a user, allowing targeted pressure application to skeletal muscles. The central node permits rotational movement of the spherical members for dynamic therapy. The device is constructed from durable materials such as polypropylene, rubber, or foam and is adaptable for temperature-specific therapy by heating or cooling the spherical members. Additionally, vibration mechanisms are integrated into the spherical members to enhance therapeutic effectiveness.

### CROSS-REFERENCE TO RELATED APPLICATION

The present application claims priority to, and the benefit of, U.S. Provisional Application No. 63/659,570, which was filed on Jun. 13, 2024, and is incorporated herein by reference in its entirety.

### FIELD OF THE INVENTION

The present invention generally relates to therapeutic devices for self-administered pain relief and muscle therapy. More specifically, the invention relates to a portable therapeutic device designed for targeted trigger point therapy and myofascial release. The device features a central node connected to a plurality of compression spherical members arranged in a tetrahedral configuration. Each compression sphere is approximately 2.5 inches in diameter and is capable of rolling and spinning along the user's appendage. The device is constructed from durable materials, such as foam, rubber, or polypropylene, and incorporates advanced features like adjustable density, integrated vibration mechanisms, and temperature adaptability for enhanced therapeutic benefits. Accordingly, this disclosure makes specific reference thereto the present invention. Nonetheless, it is to be appreciated that aspects of the present invention are also equally applicable to other like applications, devices, and methods of manufacture.

### BACKGROUND

By way of background, individuals frequently experience muscle tension, pain, and range-of-motion limitations caused by physical activity, stress, injury, or chronic conditions. Such conditions often require therapeutic interventions such as massage therapy, physical therapy, or even medical procedures. While effective, traditional massage therapy and medical interventions can be both costly and time-consuming, requiring repeated appointments with professionals, travel, and significant financial investment.

Trigger point therapy and myofascial release techniques have been used for a long time to alleviate pain and restore muscle function by targeting specific points of tension within the muscles and connective tissues. However, such therapies often require skilled practitioners or specialized equipment, making them inaccessible for many individuals who could benefit from these treatments.

Self-administered therapeutic devices provide basic relief but often lack the precision, versatility, and ergonomic design necessary for effective and sustained therapy, especially for hard-to-reach areas such as the back, shoulders, and neck. Therefore, people desire a compact, portable, and user-friendly therapeutic device that can overcome challenges faced by individuals to independently perform therapy.

Therefore, there exists a long-felt need in the art for a self-administered therapeutic device that provides effective, targeted pressure to trigger points and myofascial tissues for pain relief and muscle relaxation. There is a long-felt need for a solution that eliminates the dependence on costly and time-consuming professional therapies while maintaining the precision and effectiveness of professional interventions. Additionally, there is a long-felt need for a device that can effectively target hard-to-reach areas, such as the back, shoulders, and neck. Furthermore, there is a long-felt need for a portable, versatile, and user-friendly device that combines ergonomic design, adaptability, and advanced features such as temperature-specific therapy and vibration-enhanced massage. More specifically, there exists a long-felt need in the art for an improved self-directed therapeutic device to relieve muscle tension and improve range of motion. Finally, there exists a long-felt need in the art for a therapeutic device that allows users to perform self-directed trigger point therapy and myofascial release without requiring specialized skills or professional help.

The subject matter disclosed and claimed herein, in one embodiment, comprises an innovative self-administered therapeutic device for trigger point therapy and myofascial release. The device features a central node connected to a plurality of compression spherical members arranged in a tetrahedral configuration, allowing targeted application of pressure to skeletal muscles. The spherical members, approximately 2.5 inches in diameter, are designed to spin and roll over the user's appendage, providing a dynamic massage and tension release. The central node ensures structural stability while allowing rotational movement of the spherical members, enabling efficient therapy for hard-to-reach areas. The device is constructed from durable materials, such as rubber, foam, or polypropylene, and is capable of being heated or cooled to facilitate temperature-specific therapy.

In this manner, the therapeutic device of the present invention fulfills the aforementioned needs by offering a portable, ergonomic, and effective solution for pain relief and muscle therapy. The device enables users to perform self-directed myofascial release, deep-tissue massage, and joint mobilization with minimal effort. It eliminates the reliance on professional therapists, reduces associated costs, and provides convenient access to therapeutic benefits in any setting. The device allows muscles to be targeted that normally users can only get to through deep tissue massage therapy.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a self-administered therapeutic device for trigger point therapy and myofascial release. The device comprises a plurality of compression spherical members, each member has a diameter adapted for targeted pressure application to skeletal muscles, a central node is formed of a compression material and is configured to connect the plurality of compression spherical members in a tetrahedral arrangement, the central node provides a unitary structure and prevents lateral displacement of the spherical members while allowing rotational movement around their respective axes, wherein the spherical members are adapted to spin and roll over a user's appendage, enabling targeted application of pressure for pain relief and deep-tissue massage.

In another aspect, a connecting arm extends between the central node and each spherical member respectively, the connecting arms configured to provide structural stability and allow movement of the spherical members to facilitate self-administered therapy.

In one embodiment, the compression spherical members are constructed from materials selected from the group consisting of polypropylene, rubber, foam, foam rubber, high-density foam, wood, plastic, and combinations thereof.

In yet another aspect, the spherical members are capable of being heated or cooled to provide temperature-specific therapy.

In still another embodiment, a therapeutic device for self-directed deep-tissue massage and joint mobilization is disclosed. The device includes four identical compression spherical members, each connected to a central node via extendable and retractable connecting arms, bearings at the connections between the spherical members and the connecting arms, the bearings are configured to allow the spherical members to rotate around longitudinal and lateral axes, enabling dynamic application of pressure to multiple areas of a user's body, wherein the device is portable, ergonomically designed, and operable without requiring professional assistance.

In yet another aspect, the central node is configured to provide insulation and stability, maintaining the alignment of the spherical members during use, the device is capable of massaging hard-to-reach areas, including the back, shoulders, neck, hips, and thighs, by allowing the spherical members to roll and spin along the targeted body part, and the spherical members include internal breakable gel material for heat or cold retention to deliver therapeutic temperature effects during use.

In one aspect, the device includes a mechanism for vibration integrated into each spherical member for enhanced therapeutic effect.

In yet another aspect, a method for providing self-administered trigger point therapy and myofascial release using a therapeutic device comprising a central node and a plurality of compression spherical members connected to the central node via connecting arms is described. The method includes positioning the therapeutic device such that at least one compression spherical member contacts a target skeletal muscle of a user, applying targeted pressure by using the compression spherical members to roll or spin over the skeletal muscle, wherein the rotation and movement of the spherical members around their respective axes facilitate the release of trigger points and muscle tension, and adjusting the pressure applied by modifying the angle and force exerted on the therapeutic device, leveraging the central node for stability and control.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the self-administered therapeutic device of the present invention in accordance with the disclosed structure;

FIG. 2 illustrates a close view of connection of the central node with one of the compression spherical members in accordance with the disclosed structure of the self-administered therapeutic device;

FIG. 3 illustrates a perspective view showing a user using the self-administered therapeutic device of the present invention in accordance with one embodiment; and

FIG. 4 illustrates another embodiment of the therapeutic device of the present invention in accordance with the disclosed structure.

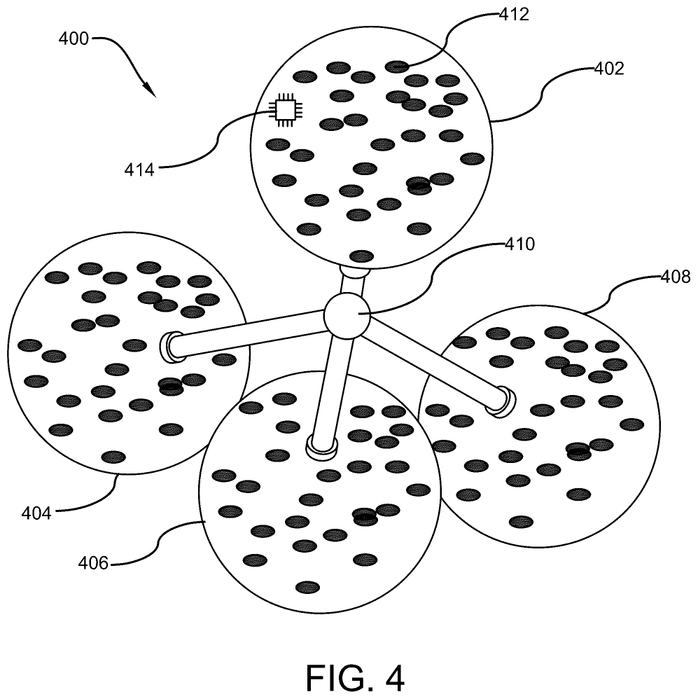

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a self-administered therapeutic device that provides effective, targeted pressure to trigger points and myofascial tissues for pain relief and muscle relaxation. There is a long-felt need for a solution that eliminates the dependence on costly and time-consuming professional therapies while maintaining the precision and effectiveness of professional interventions. Additionally, there is a long-felt need for a device that can effectively target hard-to-reach areas, such as the back, shoulders, and neck. Furthermore, there is a long-felt need for a portable, versatile, and user-friendly device that combines ergonomic design, adaptability, and advanced features such as temperature-specific therapy and vibration-enhanced massage. More specifically, there exists a long-felt need in the art for an improved self-directed therapeutic device to relieve muscle tension and improve range of motion. Finally, there exists a long-felt need in the art for a therapeutic device that allows users to perform self-directed trigger point therapy and myofascial release without requiring specialized skills or professional help.

The present invention, in one exemplary embodiment, is a therapeutic device for self-directed deep-tissue massage and joint mobilization. The device includes four identical compression spherical members, each connected to a central node via extendable and retractable connecting arms, bearings at the connections between the spherical members and the connecting arms, the bearings are configured to allow the spherical members to rotate around longitudinal and lateral axes, enabling dynamic application of pressure to multiple areas of a user's body, wherein the device is portable, ergonomically designed, and operable without requiring professional assistance.

Reference will now be made in detail to the present preferred embodiments of the invention, examples of which are illustrated in the accompanying drawings. Wherever possible, the same reference numerals are used in the drawings and the description to refer to the same or like parts.

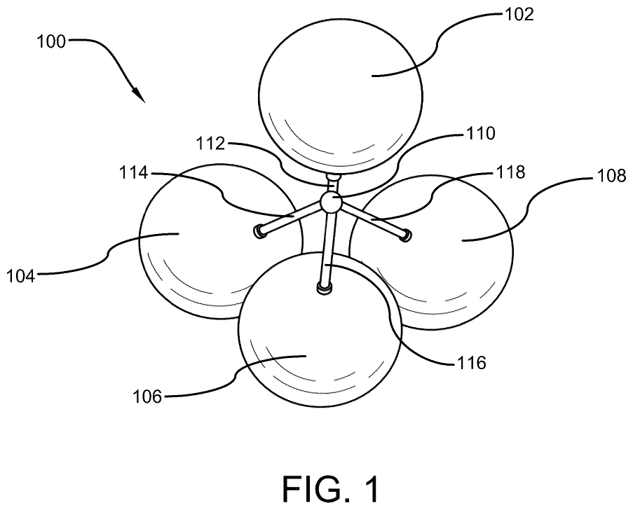

Referring initially to the drawings, FIG. 1 illustrates a perspective view of one potential embodiment of a self-administered therapeutic device 100 in accordance with the disclosed structure. The self-administered therapeutic device 100 is designed as a user-friendly and portable apparatus for self-administered trigger point therapy and myofascial release. The therapeutic device 100 facilitates the application of targeted pressure on specific trigger points to alleviate muscle tension and pain without requiring assistance from a therapist. The structural configuration of the therapeutic device 100 enhances ease of use, allowing users to apply pressure to difficult-to-reach muscle areas effectively.

The therapeutic device 100 is comprised of a plurality of compression spherical members 102, 104, 106, and 108 arranged in a tetrahedral structure. Alternative embodiments may employ different geometric arrangements to accommodate various therapeutic needs. A central node 110, formed of a compressible material, is structurally connected to each of the compression spherical members 102-108 to provide a unified framework. The central node 110 restricts lateral displacement of the spherical members 102-108 while permitting rotational movement around respective axes. This rotational capability enhances the grip and maneuverability of the therapeutic device 100 during use. Additionally, each compression spherical member 102-108 is designed to rotate about an appendage and move bidirectionally along the surface of the appendage, facilitating comprehensive massage coverage.

Each compression spherical member 102-108 preferably has a uniform diameter of approximately 2.5 inches. However, variations in size are possible to accommodate different target muscle areas. In certain embodiments, at least one of the compression spherical members 102 may exhibit a greater density than the remaining spherical members 104, 106, and 108. This density variation enables localized adjustments in pressure application, which can be beneficial for addressing specific trigger points requiring deeper penetration.

The compression spherical members 102-108 may be manufactured from a variety of materials, including, but not limited to, polypropylene, rubber, foam, foam rubber, high-density foam, wood, and plastic. The selected material is sufficiently dense to exert therapeutic pressure while possessing a degree of compliance to conform to the user's musculature. The therapeutic device 100 is designed to be capable of both heating and cooling to facilitate temperature-specific therapy techniques. The portable nature of the therapeutic device 100 allows a user to apply self-administered therapy in various locations without professional assistance. The structural configuration enables pressure application to challenging anatomical regions, such as the back, shoulders, and neck.

In some embodiments, the compression spherical members 102-108 include an outer grip texture 420. The grip texture 420 is configured to improve friction between the spherical members 102-108 and the user's body, ensuring more controlled pressure application. The grip texture 420 may be comprised of raised ridges, small bumps, or a rubberized coating to enhance stability during massage movements. The textured surface helps prevent slipping, especially when applying pressure to hard-to-reach areas.

The central node 110 is connected to the compression spherical members 102, 104, 106, and 108 via connecting arms 112, 114, 116, and 118. The connecting arms 112-118 may be constructed from plastic or other durable materials. In certain embodiments, the connecting arms 112-118 may be extendable and retractable to enable adjustments to the overall size of the therapeutic device 100. Such adjustability allows the therapeutic device 100 to accommodate users with different body sizes and therapeutic preferences.

In an alternative embodiment, the central node 110 includes a cushioning layer 422 surrounding its outer surface. The cushioning layer 422 is designed to provide additional comfort when gripping the therapeutic device 100. The cushioning layer 422 may be composed of soft silicone, foam, or gel material to reduce hand fatigue during prolonged use. The cushioning layer 422 also provides additional impact absorption, which may be beneficial when applying firm pressure to sensitive areas.

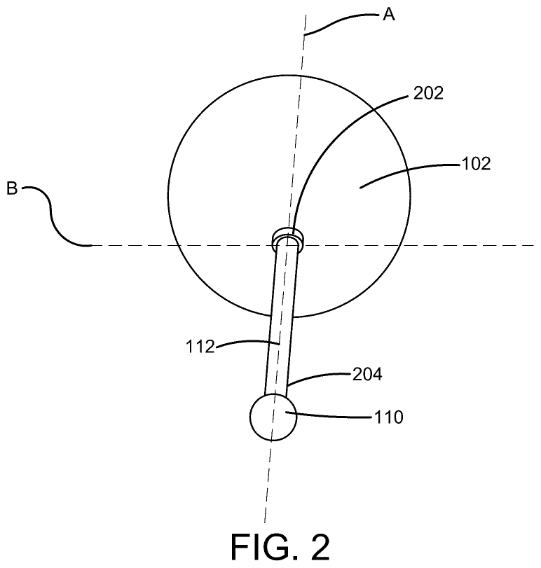

FIG. 2 provides a detailed view of the connection between the central node 110 and one of the compression spherical members 102 in accordance with the disclosed structure of the therapeutic device 100. As illustrated, the connecting arm 112 links the central node 110 to the compression spherical member 102. A bearing 202 is integrated at the connection point between the arm 112 and the compression spherical member 102, facilitating multidirectional rotation. Specifically, the compression spherical member 102 is capable of rotating around a longitudinal axis (arrow A) and a lateral axis (arrow B), allowing the therapeutic device 100 to exert pressure effectively across multiple regions of the body. The rolling and spinning movement of the compression spherical members 102-108 enhances the self-administered massage process, enabling various therapeutic techniques, including myofascial release, deep-tissue massage, and joint mobilization.

The opposite end 204 of the connecting arm 112 is secured to the central node 110. This connection stabilizes the central node 110 while reinforcing the structural integrity of the therapeutic device 100. The fixed attachment of the central node 110 to the connecting arms 112-118 prevents excessive movement during use, ensuring consistent and controlled pressure application.

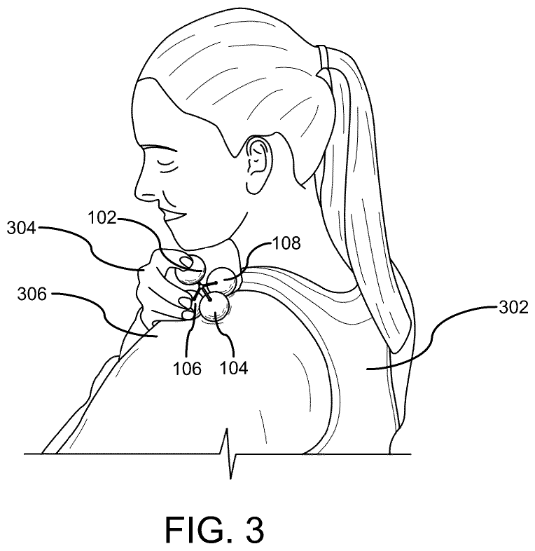

FIG. 3 illustrates a perspective view of a user 302 utilizing the self-administered therapeutic device 100 in accordance with one embodiment. The user 302 holds the therapeutic device 100 in a hand 304 and applies it to a targeted muscle group or appendage 306. The structural arrangement of the compression spherical members 102-108 allows the user 302 to administer pressure precisely to skeletal muscles 306, facilitating targeted trigger point therapy. The compact and ergonomic design of the therapeutic device 100 enables effective self-application without requiring external assistance.

The structural configuration of the compression spherical members 102-108 allows the therapeutic device 100 to be used on multiple body regions. The therapeutic device 100 may be applied to the neck, shoulders, back, hips, thighs, calves, palms, and other muscle groups. The adaptability of the therapeutic device 100 makes it suitable for a range of users, including athletes, individuals with muscle stiffness, and those seeking general muscle relaxation.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein, “self-administered therapeutic device”, “portable multi-sphere device for deep-tissue massage”, “therapeutic device”, and “device” are interchangeable and refer to the self-administered therapeutic device for trigger point therapy and myofascial release 100, 400 of the present invention.

Notwithstanding the foregoing, the self-administered therapeutic device for trigger point therapy and myofascial release 100, 400 of the present invention can be of any suitable configuration as is known in the art without affecting the overall concept of the invention, provided that it accomplishes the above-stated objectives. One of ordinary skill in the art will appreciate that the self-administered therapeutic device for trigger point therapy and myofascial release 100, 400 as shown in the FIGS. are for illustrative purposes only, and that many other configurations of the self-administered therapeutic device for trigger point therapy and myofascial release 100, 400 are well within the scope of the present disclosure. Although the dimensions of the self-administered therapeutic device for trigger point therapy and myofascial release 100, 400 are important design parameters for user convenience, the self-administered therapeutic device for trigger point therapy and myofascial release 100, 400 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A self-administered therapeutic device comprising:
a spherical member;
a central node connected to the spherical members, wherein the central node prevents a lateral displacement of the spherical members while allowing the spherical member to rotate around an axis; and
a connecting arm having a first end attached to the central node and a second end attached to the spherical member.

2. The self-administered therapeutic device of claim 1, wherein the connecting arm is comprised of an extendable arm.

3. The self-administered therapeutic device of claim 1, wherein the connecting arm is comprised of a retractable arm.

4. The self-administered therapeutic device of claim 1, wherein the spherical member can rotate around a longitudinal axis of the self-administered therapeutic device.

5. The self-administered therapeutic device of claim 1, wherein the spherical member is comprised of a grip texture.

6. The self-administered therapeutic device of claim 5, wherein the grip texture is comprised of a raised ridge, a bump, or a rubberized coating.

7. The self-administered therapeutic device of claim 1, wherein the spherical member is comprised of a cushioning layer.

8. The self-administered therapeutic device of claim 7, wherein the cushioning layer is comprised of a silicone, a foam, or a gel.

9. The self-administered therapeutic device of claim 1, wherein the spherical member can rotate around a lateral axis of the self-administered therapeutic device.

10. A self-administered therapeutic device comprising:
a spherical member;
a central node connected to the spherical members, wherein the central node prevents a lateral displacement of the spherical members while allowing the spherical member to rotate around an axis; and
a connecting arm having a first end attached to the central node and a second end attached to the spherical member, the connecting arm comprised of a bearing.

11. The self-administered therapeutic device of claim 6, wherein the connecting arm is comprised of an extendable arm.

12. The self-administered therapeutic device of claim 6, wherein the connecting arm is comprised of a retractable arm.

13. The self-administered therapeutic device of claim 6, wherein the spherical member can rotate around a longitudinal axis of the self-administered therapeutic device via the bearing.

14. The self-administered therapeutic device of claim 6, wherein the spherical member can rotate around a lateral axis of the self-administered therapeutic device via the bearing.

15. The self-administered therapeutic device of claim 1, wherein the spherical member is comprised of a grip texture.

16. The self-administered therapeutic device of claim 5, wherein the grip texture is comprised of a raised ridge, a bump, or a rubberized coating.

17. The self-administered therapeutic device of claim 1, wherein the spherical member is comprised of a cushioning layer.

18. The self-administered therapeutic device of claim 7, wherein the cushioning layer is comprised of a silicone, a foam, or a gel.

19. A self-administered therapeutic device comprising:
a spherical member;
a central node connected to the spherical members, wherein the central node prevents a lateral displacement of the spherical members while allowing the spherical member to rotate around an axis; and
a connecting arm having a first end attached to the central node and a second end comprised of a bearing that is attached to the spherical member.

20. The self-administered therapeutic device of claim 19, wherein the spherical member can rotate around a longitudinal axis and a lateral axis of the self-administered therapeutic device via the bearing.
